(19) United States
(12) Patent Application Publication
(10) Pub. No.: US 2018/0240124 A1
(43) Pub. Date: Aug. 23, 2018

(54) WARRANTY TRACKING SYSTEM

(71) Applicant: Wal-Mart Stores, Inc., Bentonville, AR (US)

(72) Inventors: Balasubramanian Natarajan, Bentonville, AR (US); Kalaiselvan Muniyan, Bentonville, AR (US); Karunanithi Sivasubramanian, Bentonville, AR (US); Murugesapandian Thangaraj, Bentonville, AR (US)

(21) Appl. No.: 15/875,434

(22) Filed: Jan. 19, 2018

Related U.S. Application Data
(60) Provisional application No. 62/462,626, filed on Feb. 23, 2017.

(51) Int. Cl. G06Q 30/00

(52) U.S. Cl. CPC G06Q 30/012; G06Q 30/0278; G06Q 30/014

(57) ABSTRACT

Described is a system and method for warranty tracking. The system allows customers to register a purchased product in the system at the point of sale. A replacement product is automatically purchased at the end of product life and/or warranty expiration. The warranty expiration may be based on the warranty expiration date and/or the operating conditions of the purchased product. The operating conditions are recorded by the purchased product and may result in voiding of the warranty.

### CROSS REFERENCE TO RELATED APPLICATION

This application claims the benefit of U.S. Provisional Patent Application No. 62/462,626 filed on Feb. 23, 2017 and entitled “Warranty Tracking System”, the contents of which are incorporated herein in their entirety.

### FIELD OF THE INVENTION

The invention relates generally to a system and method for tracking warranty information of a purchased product. The system allows for automatic purchase of a replacement product and monitoring of operating conditions of a purchased product.

### BACKGROUND

When a customer is met with a home appliance failure, he/she has to decide whether to call the product's warranty or service provider. The customer may not remember the make and model of a warranted product. The customer may not even remember to register the product. In addition, the product must be operated in accordance with the terms and conditions of the warranty. Improper operation may void the warranty. In some cases, a warranty may no longer be effective based on the age and condition of the product.

It is desirable for the customer to be able to identify a product's current warranty status and/or the service provider's information. It is further desirable for a customer to have a replacement product automatically purchased based on the warranty status.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a flow diagram of an embodiment of the warranty tracking system according to the invention; and

FIG. 2 illustrates a flow diagram of an embodiment of the warranty tracking system according to the invention.

### DETAILED DESCRIPTION

Disclosed herein is a system to track a warranty of a purchased product comprising the purchased product configured to record and store operating conditions; a product registration module configured to add the warranty of the purchased product to the system; a warranty registration module configured to register the purchased product and store warranty information in the system; a preauthorization module configured to add and store payment information of a purchaser; a purchaser computing device configured to receive approaching warranty expiration date notification and approaching end of useful life of the purchased product notification; and a purchasing module configured to automatically purchase a replacement product. The purchased product may be a smart product. The purchased product may comprise a smart chip. The purchased product may comprise a sensor.

The automatic purchase of the replacement product may be at the end of useful life of the purchased product using the stored payment information. The end of useful life may be calculated based on product age, operating conditions, product life and/or product repair history. The product life may be calculated based on warranty expiration date and warranty services requested for the purchased product. The warranty expiration date may be the actual warranty expiration date. The warranty expiration date may be the warranty void date based on the operating conditions. The point of service module may comprise a barcode scanner. The warranty information may comprise warranty period, rebate deadline, return deadline and/or receipt image. The preauthorization module may be configured to store a maximum preauthorized price of the replacement product. The operating conditions may void the warranty before the warranty expiration.

Disclosed herein is a method for tracking a warranty of a purchased product comprising adding the warranty of the purchased product to a warranty tracking system; preauthorizing the warranty tracking system to buy a replacement product; sending a notification of approaching warranty expiration date and a notification of end of useful life of the purchased product from the warranty tracking system to a purchaser's computing device; storing and recording operating conditions of the purchased product; and automatically purchasing a replacement product. The method may comprise adding the warranty of the purchased product at a point of service terminal. The method may comprise scanning a barcode of the purchased product for warranty information. The warranty of the purchased product may be added to the warranty tracking device using a customer interface module.

The warranty information may comprise warranty period, warranty expiration date, rebate deadline, return deadline and/or receipt image. The preauthorizing may comprise adding and storing a purchaser's payment information. The preauthorizing may comprise adding and storing a maximum preauthorized price of the replacement product. The operating conditions may void the warranty before the warranty expiration date. The automatic purchase of the replacement product may be at an end of useful life of the purchased product using the stored payment information. The end of useful life may be calculated based on product age, operating conditions, product repair history and/or product life. The product life may be calculated based on warranty expiration date, average proposed lifetime and warranty services requested for the purchased product. The warranty expiration date may be the actual warranty expiration date. The warranty expiration date may be the warranty void date based on the operating conditions. The purchased product may comprise a smart chip. The purchased product may comprise a sensor.

The warranty tracking system functions help both customers and retailers. The warranty tracking system helps the customer to register and activate the manufacturer warranty with the manufacturer by providing web application programming interface (API) to integrate with different manufacturers. A maintenance and price change alert function helps the customer to buy the product systematically while the customer is away from the system. A locate the product function helps the customer to maintain the location details of the previous items that were stored physically. Easier insurance claims helps the customer to find the warranty and product information electronically at their fingertips. Geospatial data may help the retailer to improve their store's shelf availability and customer satisfaction.

The warranty tracking system can store important information such as warranty period, rebate deadline, return deadline and/or receipt image. The warranty tracking system may be a barcode scanning driven system.

A customer may be able to electronically maintain and track their purchased products such as electronic products and home appliances. The warranty tracking system may include warranty expiration tracking, managing of personal assets, new product recommendations, service provider information, insurance claim information, personal catalog, product location, receipt management, legal document renewal, and/or maintenance and price change alerts.

The purchased products according to the invention comprise smart technology, combining a physical product with additional warranty tracking services. The purchased products according to the inventions are products embedded with, for example, processors, sensors, software and connectivity that allow data to be exchanged between the products and the warranty tracking cloud service, manufacturer, customer (operator/user), and other products and systems. The connectivity also enables some capabilities of the product to exist outside the physical product in a product cloud. The data collected from the products can be then analyzed to inform warranty decision-making on the part of the customer and retailer.

Smart purchased products as used herein are products purchased by the customer, wherein the products include smart technology, such as sensors, microprocessors, data storage, controls, software, and/or an embedded operating system with enhanced user interface. The connectivity function includes ports, antennae, and protocols enabling wired and/or wireless connections that allow data to be exchanged with the purchased product and the warranty tracking cloud service. Monitoring of the product's operations is a function of the sensors.

In some embodiments, a smart chip (small microprocessor) is attached to the product during manufacture to record the operating conditions and/or any possible issues with the product. The smart chip may be programmed to collect data periodically, i.e. daily, weekly, monthly, and transmit the same to the warranty tracking system via home or business internet. The operating conditions module will process the collected data against a set of rules defined for purchased product warranty by the warranty provider. The smart chip may communicate with the warranty tracking cloud service when an error code occurs and/or communicate the error code to the customer.

Sensors and sensing information representative of operating conditions may include weight sensors, pressure sensors and/or temperature sensors. The smart purchased product may further comprise a telecommunication device. The telecommunications device is configured to communicate with the warranty tracking cloud service.

In some embodiments, when possible violations of the product operating conditions for the warranty registered product are detected, the warranty tracking system may warn the consumer about the possible violation to course correct operating procedure. The warranty may be void and/or will become void based on the operating conditions. Otherwise, the product warranty would be void.

In some embodiments, product malfunctions may be captured and shared with a warranty service provider to speed up the resolution process. If the purchased product does not perform to the manufacturer's specifications; a warranty order for a new product may be placed and the customer notified.

With the warranty tracking system and method according to the invention, a customer purchases the smart product and brings the purchased product to his home or business. In some embodiments, the purchased product is given as a gift and the recipient brings the purchased product to his home or business. Once the purchased product is plugged in and/or turned on, the purchased product will try to connect to the home wireless network per manufacturer's instructions. Once the product wireless network setup is completed, smart technology, such as a smart chip, tries to communicate with the warranty tracking cloud service through home or business internet. Once the warranty tracking cloud service connection is established, the smart chip may connect to the product registration service by sending the product information (the purchase details of the product including serial number where applicable) and e-Receipts and additional warranty information shall be captured and stored from POS. When the purchased product connects thru a home network, the purchased product at home will connect with the one added by POS. The registration of the purchased product is initiated with the manufacturer as soon as the purchased product connects to the warranty tracking application server by home network connection and/or geo-location information. After the purchased product registration is completed, the customer will receive alerts about the new product added to a warranty tracking application on a customer computing device, such as a mobile computing device application. The smart chip may also record the purchased product operating conditions and alert the customer on their warranty tracking application.

The warranty tracking system and method according to the invention tracks the product warranty from the product date of purchase which allows customers to renew/buy additional warranty based on the product repair history. A product recall service alerts the customer when the product manufacture does a recall on the purchased product. A preauthorization service allows customers to buy a replacement product at a price customer set or find the better deal. A product valuation service calculates a product's current value based on the product lifetime, product repair history, new product available in the market and so on. An operating conditions service warns the customer about the product operating conditions which void the warranty. The operating conditions service periodically collects the product operating conditions and updates the product repair history. A product registration service registers purchased product and captures warranty information such as purchase date and location.

Product valuation includes collecting the purchased product information to calculate the end of the life of the purchased product. The purchased product information may include purchase price, purchase date, and/or warranty information. Warranty information may include extended and/or store warranty from the purchased product database. The average product life time recommended by the product manufacturer is collected. The product repair details from the database and/or warranty service providers are collected. The product depreciation value based on the product age (% of time remaining from the date of purchase), product purchase price, repair/service history and product repair cost is calculated.

Product repair categories may be divided into categories based on general terms, such as Critical, Major, Minor and Trivial. “Critical,” as used herein, is defined as malfunction of the product, and/or about 50% or more of the purchase price for repair costs. “Major,” as used herein, is defined as malfunction of a few features of the product and/or in the range of from about 20% to less than about 50% of the cost for the repair of the purchase price. “Minor,” as used herein, is defined as issues that would not impact basic operations of the product and/or about 5% to less than about 20% of the purchase price. “Trivial,” as defined herein, is defined as cosmetic issues and/or less than about 5% of the purchase price to correct the issue. A new replacement product price is compared with the remaining value of the purchased product remains value.

For product valuation determination and replacement, a recommended product search based on the current product may be created. When the current product is out of market, details of a similar product in market are collected. The product specifications along with suggested retail price are collected. A product repair quote along with time line to fix the issue is requested. The current value of the product is determined by a product life calculation, from current retail price in the market or similar product retail price and average depreciation value of the product by year. A new similar/upgraded product price quote in market (price and product features) is requested. A determination of whether to go with a new product or repair the existing product by adding up a product age assigned to current value of the product, remaining life time and repair cost versus similar/upgraded product retail price, average new product lifetime. An alert to the customer based on the above information is sent.

In some embodiments, a new product search may be run. The customer's registered product information (product description, make, color, features, and customer price preference) in product database is used to create a search. Based on the customer product information to create the search agent to call the product manufacturer to find the new existing product details. The customer's product preferences are checked against new/existing available product features and the customer product database is updated. The customer is alerted based on the customer product preference when there is a match or when purchase of a new product is necessary.

Preauthorization includes two types of preauthorization, time bound and guaranteed price. For example, the warranty tracking system will purchase a new product if the price goes up to a certain percentage above the customer demand price. Customer preferences are collected, such as holiday return (extended) policy, product match or upgrade (brand, model, features & warranty), delivery timeline, shipping and handling (cost), multiple payment card options and/or customer ratings. A quote based on the customer preference(s) is requested.

The preauthorization may include card provisioning, such as a mobile wallet used as payment card storage. Card provisioning allows the customer to key in the card information along with card verification value (CVV). CVV would be validated with the card issuers and the CVV results will be stored in the mobile wallet. A card expiration is alert to customer in advance of card expiration.

The warranty tracking system may include additional features, such as warranty term, free shipping, customer ratings, delivery time, and retailer price. Based on the customer's preauthorization type and quote, a determination of whether the order shall be placed immediately or shall be deferred to meet the customer's asking price or guaranteed price plus or minus the percentage chosen by customer. The warranty tracking system will secure the purchase with retailer and Initiate purchase process: receive a final confirmation from customer if a customer notify before final purchase option is selected. The order will be placed with selected retailer merchant using pre-authorized payment card information. Order confirmation will be sent from retailer and the product database will be updated. Alert will be sent to customer with order details.

In some embodiments, the warranty tracking system is a computer program, but it is to be understood that warranty tracking system can take many forms and implementations, including hardware, software, or both. The warranty tracking system can be a resident on a cloud based server. In some embodiments, the warranty tracking system can be a part of any computational equipment. In some embodiments warranty tracking system is implemented in hardware processors. The hardware processors can be application specific integrated circuits (ASICs) or hardware accelerators, for example. The hardware processors can be part of one or more special purpose computers that execute computer program instructions which implement one or more functions and operations of warranty tracking system. In a specific embodiment, the warranty tracking system includes specialized hardware accelerator integrated circuits designed to perform specific inventory management tasks.

The database is any type of database useful for the purpose of storing data. The database can be electronic and/or computerized. The database may be stored on memory on a server in electronic communication with the warranty tracking system. The database can be on in memory hard disk or other storage medium.

Communication may be wireless communication between a mobile computing device and the warranty tracking system of a server, but this is not meant to be limiting. Wireless communication can be a Bluetooth communication, a wireless local area network communication, wireless cellular telephone communication, or any other form or type of wireless communication. In some embodiments, communication may be wired or optical communication. Communication may be can be implemented by any type of transmitter/receiver elements known in the art now or in the future for data transfer between a mobile computing device and an electronic or computer system.

The warranty tracking system may include a point of service module, a warranty registration module, a preauthorization module, an operating conditions module, a product recall module, a warranty tracking module, a product valuation module and a purchasing module. A “module”, as used in this document, can be a circuit, a software program, a hardware apparatus, an application specific integrated circuit, a special purpose computer, or a combination of hardware and software circuits, systems, or implementations. A module can be any element, thing, or program that accepts one or more input and provides one or more output. The warranty tracking system in this embodiment is a computer implemented system, but this is not meant to be limiting. The warranty tracking system can be implemented in hardware, firmware, software, or any combination of these. In a particular embodiment, the modules are each implemented as an application specific integrated circuit that includes specialized hardware accelerator integrated circuits designed to perform specific warranty tracking tasks. In another embodiment, the modules are each implemented as a hardware processor. In some embodiments, each hardware processor is a hardware accelerator that interfaces with a computer program. In some embodiments, each hardware processor is a part of one or more special purpose computer that executes computer program instructions.

In some embodiments, data capture of warranty information is a barcode scan of a barcode of a purchased product at a point of service module. In some embodiments data capture of warranty information is through a customer interface module.

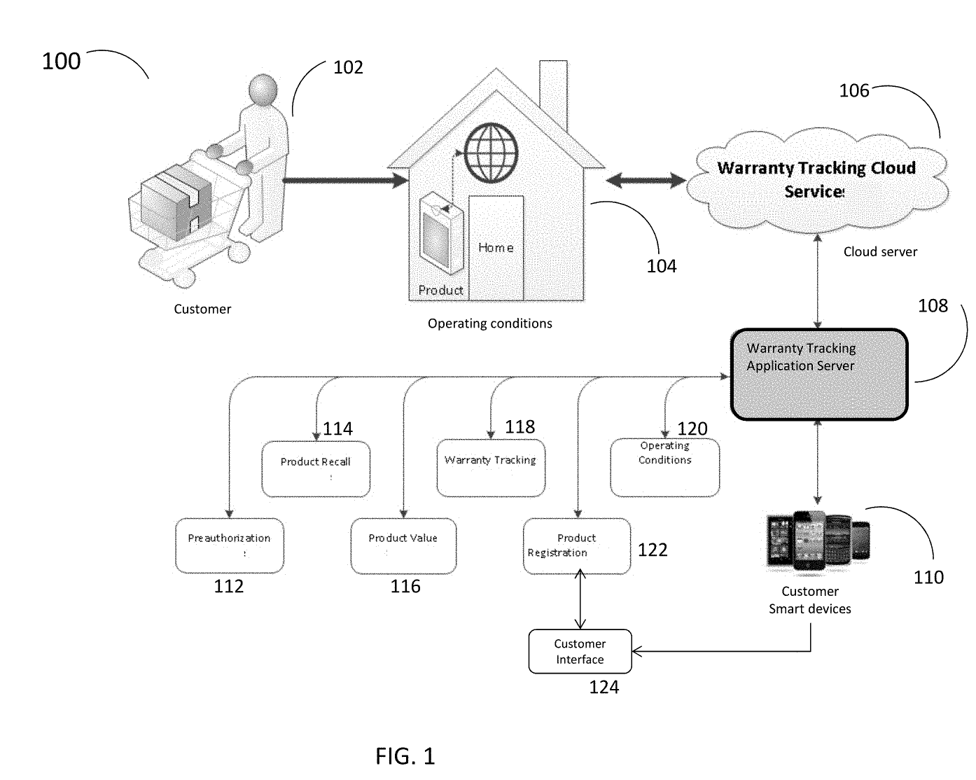

FIG. 1 illustrates a warranty tracking system and method 100. A customer purchases a product 102 and brings the purchased product to a home or business and turns on the purchased product, for example by connecting to a power source 104 to activate smart technology. When the purchased product is plugged in, the purchased product will try to connect to the home or office wireless network. Once the purchased product wireless network set up is complete, the smart technology communicates with warranty tracking cloud service 106 which communicates with warranty tracking application server (database) 108.

Once the warranty tracking cloud service connection is established, the smart technology communicates with warranty tracking cloud service 106 by capturing product information, such as operating conditions, serial number and geo-location information. The smart technology records the purchased product operating conditions and communicates and alerts customer on their computing device 110.

Warranty tracking module 118 tracks the purchased product warranty from the purchased product date of purchase Warranty tracking module 118 also allows the customer to renew/buy additional warranties based on the purchased product repair history. Product recall module 114 alerts the customer when the purchased product manufacture does a recall on the product. Preauthorization module 112 automatically purchases the product at a price customer initially sets through warranty tracking application on customer computing device 110.

Product valuation module 116 calculates purchased product current value based on purchased product life time, purchased product repair history, and/or new like product available in the market. Operating conditions communication module 120 alerts the customer about purchased product operating condition which may void the warranty. Operating conditions communication module 120 periodically collects, for example monthly, the purchased product operation condition and sends to the warranty tracking application server and sends updates of the product repair history to the warranty tracking application server.

Product registration module 122 communicates with customer interface module 124. Customer registers purchased product information (purchase date and location), through a customer interface on customer computing device 110.

In an example embodiment of FIG. 1, a customer purchases a smart product, such as a refrigerator, and brings the refrigerator to his home. The refrigerator is connected to the home wireless network according to the refrigerator manufacturer's instructions.

The customer downloads the warranty tracking application on his smart device. The customer registers the refrigerator through customer interface module 124 and product registration module 122. Once one purchased product is registered, a warranty tracking application listening mechanism may identify a new purchased product and add the new purchased product to a registered product database on warranty tracking application server 108. The warranty tracking application collects new purchased product information by communicating, for example, with an Internet of Things (IoT) smart chip on the new purchased product and alerts the customer. The customer may respond to the alert and open the previously downloaded warranty tracking application in order to register the new purchased product and/or decline to register.

After the refrigerator registration, the warranty tracking application connects to warranty tracking centralized cloud service 106 and warranty tracking application server 108. The customer then initiates the refrigerator registration with the manufacturer and/or a third part warranty provider, activating the manufacturer's warranty and/or third party warranty provider's extended warranty with a single click. The refrigerator warranty information is added from the manufacturer and/or third party warranty provider and stored within warranty tracking application server 108. If the customer declines to register the refrigerator with the manufacturer and/or third party warranty provider, the refrigerator warranty information is still stored as a purchased product waiting to be registered. The customer may register a purchased product at any time.

Operating conditions module 120 monitors the home network for any events originating from the refrigerator connected to the network. If the refrigerator is not operated according to the terms of the warranty, warranty tracking module 120 alerts the customer about a possible decline of warranty coverage based on the operating conditions. If the operating conditions are not in compliance with the terms of the warranty, the warranty may become null and void. In addition, if the operating conditions are not in compliance with the terms of the warranty and if the actual warranty expiration date has not yet expired, a warranty service provider is notified to schedule an appointment with the customer. If the warranty is no longer available, a list of service providers and repair estimates will be sent to the customer.

Valuation module 116 determines the current valuation of the refrigerator and proposed life left. By comparing the current valuation and proposed life left, the warranty tracking system will suggest whether the refrigerator should be replaced. If the warranty tracking system determines that the refrigerator does not need to be replaced, then the product depreciation is calculated based on the current valuation.

If the refrigerator is identified as needed to be replaced, the warranty tracking system determines if purchase preauthorization exists. Preauthorization module 112 determine whether the purchased product is to be replaced within a certain time frame (mandatory or optional) and/or or until it matches the customer's maximum preauthorized price (mandatory or optional). A price quote from multiple merchants that carry the purchased product and/or a similar product if the purchased product is not available, is requested. If the maximum preauthorized price is met by a merchant and the replacement is mandatory, the refrigerator is purchased automatically for the customer. If the maximum preauthorized price is too high, the merchant is requested to alert the customer when the maximum preauthorized price is met. If preauthorization is based on a certain time frame and the replacement is mandatory, the lowest price for the purchased product and/or a similar product if the purchased product is not available is requested and the replacement product is purchased automatically. In either case, when replacement is optional, the customer is notified before automatic purchase.

Warranty tracking module 118 is configured to notify the customer of the warranty status of the refrigerator. If a registered purchased product is nearing the warranty expiration date, warranty tracking module 118 will notify the customer about the impending purchased product warranty expiration date and options to extend the warranty.

Product recall module 114 is configured to notify the customer if/when the refrigerator is being recalled by the manufacturer and update the database for the purchased product as recalled. The customer is notified about the recall and options are provided to return the refrigerator (online or in-store) if the customer is planning to return the purchased product. Once the refrigerator is returned, the purchased product is archived from the registered product database. If the customer is not planning to return the refrigerator, the customer will be continuously reminded about the recall until the customer chooses not to receive the recall notification related to the refrigerator.

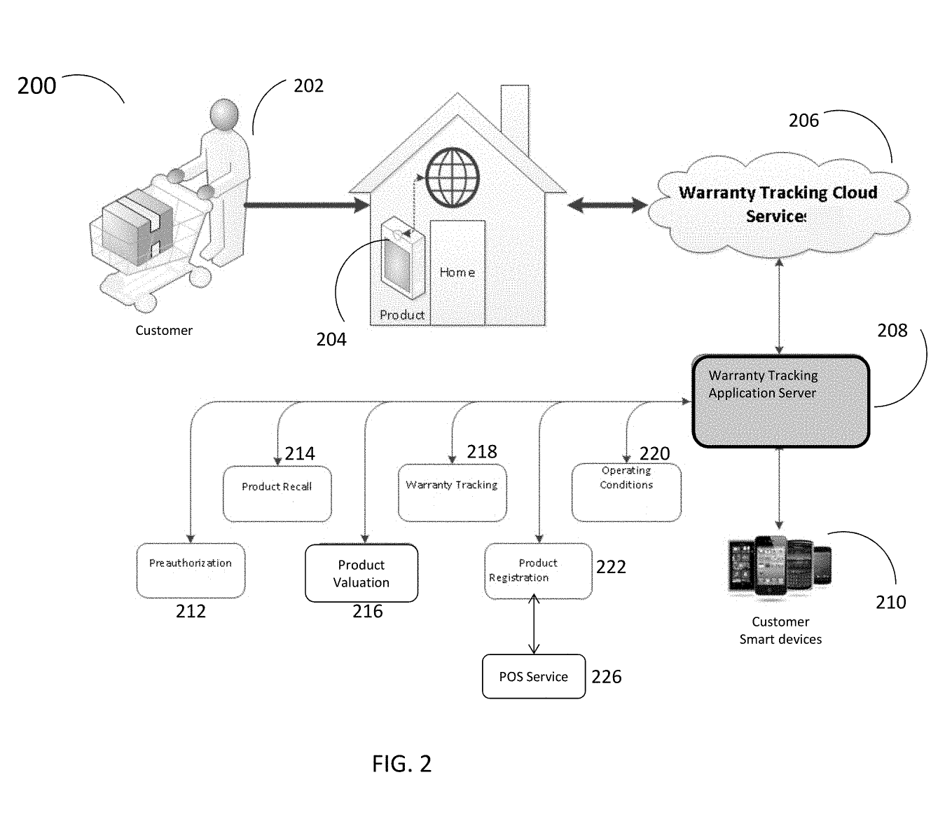

FIG. 2 illustrates a warranty tracking system and method 200. A customer purchases a product 202 and brings the purchased product to a home or business and turns on the purchased product, for example by connecting to a power source 204 to activate smart technology. When the purchased product is plugged in, the purchased product will try to connect to the home or office wireless network. Once the purchased product wireless network set up is complete, the smart technology communicates with warranty tracking cloud service 206 which communicates with warranty tracking application server (database) 208.

Once the warranty tracking cloud service connection is established, the smart technology communicates with warranty tracking cloud service 206 by capturing product information, such as operating conditions, serial number and geo-location information. The smart technology records the purchased product operating conditions and communicates and alerts customer on their computing device 210.

Warranty tracking module 218 tracks the purchased product warranty from the purchased product date of purchase Warranty tracking module 218 also allows the customer to renew/buy additional warranties based on the purchased product repair history. Product recall module 214 alerts the customer when the purchased product manufacture does a recall on the product. Preauthorization module 212 automatically purchases the product at a price customer initially sets through warranty tracking application on customer computing device 210.

Product valuation module 216 calculates purchased product current value based on purchased product life time, purchased product repair history, and/or new like product available in the market. Operating conditions communication module 220 alerts the customer about purchased product operating condition which may void the warranty. Operating conditions communication module 220 periodically collects, for example monthly, the purchased product operation condition and sends to the warranty tracking application server and sends updates of the product repair history to the warranty tracking application server.

Product registration module 222 communicates with POS module 226 wherein POS module 226 captures purchased product information such as product name, serial number purchase date and location.

As will be appreciated by one skilled in the art, aspects of the disclosed warranty tracking system may be embodied as an electronic system, a method, or a computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing.

Computer program code for carrying out operations for aspects of the present invention may be written in any combination of one or more programming languages, including an object oriented programming language or conventional procedural programming languages, such as the “C” programming language or similar programming languages. The program code may execute entirely on the retail store's computer, partly on the store's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or hardware accelerators or application specific integrated circuits.

While the invention has been shown and described with reference to specific preferred embodiments, it should be understood by those skilled in the art that various changes in form and detail may be made therein without departing from the spirit and scope of the invention as defined by the following claims.

What is claimed is:

1. A system to track a warranty of a purchased product comprising:
the purchased product configured to record and store operating conditions;
a product registration module configured to add the warranty of the purchased product to the system;
a warranty registration module configured to register the purchased product and store warranty information in the system;
a preauthorization module configured to add and store payment information of a purchaser;
a purchaser computing device configured to receive approaching warranty expiration date notification and approaching end of useful life of the purchased product notification; and
a purchasing module configured to automatically purchase a replacement product.

2. The system of claim 1, wherein the purchased product comprises a smart chip and/or a sensor.

3. The system of claim 1, wherein the automatic purchase of the replacement product is at an end of useful life of the purchased product using the stored payment information.

4. The system of claim 3, wherein the end of useful life is calculated based on product age, product life and/or product repair history.

5. The system of claim 4, wherein the product life is calculated based on warranty expiration date and warranty services requested for the purchased product.

6. The system of claim 5, wherein the warranty expiration date is an actual warranty expiration date.

7. The system of claim 5, wherein the warranty expiration date is a warranty void date based on the operating conditions.

8. The system of claim 1, wherein the product registration module is a point of service module.

9. The system of claim 8, wherein the point of service module comprises a barcode scanner.

10. The system of claim 1, wherein the warranty information comprises warranty period, rebate deadline, return deadline and/or receipt image.

11. The system of claim 1, wherein the preauthorization module is configured to store a maximum preauthorized price of the replacement product.

12. The system of claim 1, wherein the operating conditions void the warranty before an actual warranty expiration date.

13. A method for tracking a warranty of a purchased product comprising:
adding the warranty of the purchased product to a warranty tracking system, wherein the purchased product comprises a smart chip and/or a sensor;
preauthorizing the warranty tracking system to buy a replacement product;
sending a notification of approaching warranty expiration date and a notification of end of useful life of the purchased product from the warranty tracking system to a purchaser's computing device;
storing and recording operating conditions by the purchased product; and
automatically purchasing a replacement product.

14. The method of claim 13, wherein the warranty of the purchased product is added to the warranty tracking database at a point of service terminal.

15. The method of claim 14, further comprising scanning a barcode of the purchased product for warranty information.

16. The method of claim 13, wherein the warranty of the purchased product is added to the warranty tracking device using a customer interface module.

17. The method of claim 13, wherein the preauthorizing comprises adding and storing a purchaser's payment information and a maximum preauthorized price of the replacement product.

18. The method of claim 13, wherein the operating conditions void the warranty before the warranty expiration date.

19. The method of claim 13, wherein the automatic purchase of the replacement product is at an end of useful life of the purchased product using the stored payment information.

20. The method of claim 19, wherein the end of useful life is calculated based on product age, product life and/or product repair history, and wherein the product life is calculated based on warranty expiration date and warranty services requested for the purchased product.
